(19) United States
(12) Patent Application Publication
(10) Pub. No.: US 2025/0231806 A1
(43) Pub. Date: Jul. 17, 2025

(54) PERIPHERAL DEVICES IN A SPLIT-COMPUTE ARCHITECTURE

(71) Applicant: Google LLC, Mountain View, CA (US)

(72) Inventors: James Carr, San Francisco, CA (US); Mark Sander Urbanus, San Jose, CA (US); Meltem Oktem, San Jose, CA (US); Patrick Plunkett, Santa Clara, CA (US); Akshay Joshi, Mountain View, CA (US); Charlie Gengzao Wang, Fremont, CA (US)

(21) Appl. No.: 18/854,912

(22) PCT Filed: Apr. 26, 2023
(86) PCT No.: PCT/US2023/020049

§ 371 Date: Oct. 7, 2024

Related U.S. Application Data
(60) Provisional application No. 63/363,592, filed on Apr. 26, 2022.

(51) Int. Cl. G06F 9/50; G02B 27/01; G06F 3/01

(52) U.S. Cl. CPC G06F 9/5027; G02B 27/017; G06F 3/012; G06F 3/013; G02B 2027/0178; G06F 2209/509

(57) ABSTRACT

A method including communicatively coupling a wearable device with a companion device, mirroring, by the wearable device, data obtained from a peripheral device of the wearable device on the companion device as peripheral data, including obtaining, by the wearable device, the peripheral data from the peripheral device, and communicating, by the wearable device, the peripheral data to the companion device, receiving, by the companion device, the peripheral data and processing the peripheral data into processed data, sending, by the companion device, the processed data to the wearable device, and receiving, by the wearable device, the processed data and utilizing the processed data to complete a computing process.

### CROSS REFERENCE TO RELATED APPLICATIONS

This application claims the benefit and priority to U.S. Provisional Patent Application No. 63/363,592, filed on Apr. 26, 2022, entitled “SPLIT-COMPUTE ARCHITECTURE”, the disclosure of which is incorporated by reference herein in its entirety.

This application also incorporates by reference herein the disclosures to related co-pending applications, PCT Application No. PCT/US2023/019563, filed Apr. 24, 2023, PCT Application No. PCT/US2023/019832, filed Apr. 25, 2023, “SPLIT-COMPUTE ARCHITECTURE”, filed Apr. 26, 2023 (Attorney Docket No. 0120-497WO1), “PERIPHERAL DEVICES IN A SPLIT-COMPUTE ARCHITECTURE”, filed Apr. 26, 2023 (Attorney Docket No. 0120-498WO1), “MULTIPLE APPLICATION RUNTIMES IN A SPLIT-COMPUTE ARCHITECTURE”, filed Apr. 26, 2023 (Attorney Docket No. 0120-505WO1), and “MACHINE LEARNING PROCESSING OFFLOAD IN A SPLIT-COMPUTE ARCHITECTURE”, filed Apr. 26, 2023 (Attorney Docket No. 0120-509WO1).

### FIELD

Implementations relate to a wearable device processing architecture.

### BACKGROUND

Some devices (e.g., wearable devices) can have advanced display capabilities. These devices can be challenged to fit sufficiently capable electronics into a small form factor. These issues become increasingly challenging in applications, such as accessibility, where a device might be expected to be worn for a full day.

Existing commercially available systems cannot support continuous usage scenarios. For example, wearable devices (e.g., smart glasses, smart watches, head mounted displays, and the like) are intended for intermittent engagement and are built around phone-class System-on-Chips (SoCs). These devices can provide only a few hours of battery life with a display on. In addition, thermal comfort can be an issue due to the small volume head mounted displays.

### SUMMARY

Example implementations include a wearable device and a companion device using a split-compute architecture. To conserve wearable device resources, the companion device can process computing tasks that otherwise would be performed by the wearable device. The wearable device can include peripheral devices that generate peripheral device data that is stored in a memory of the wearable device. The split-compute architecture can be configured to facilitate the mirroring of the peripheral device data on the companion device and/or the wearable device.

In a general aspect, a device, a system, a non-transitory computer-readable medium (having stored thereon computer executable program code which can be executed on a computer system), and/or a method can perform a process with a method including communicatively coupling a wearable device with a companion device, mirroring, by the wearable device, data obtained from a peripheral device of the wearable device on the companion device as peripheral data, including obtaining, by the wearable device, the peripheral data from the peripheral device, and communicating, by the wearable device, the peripheral data to the companion device, receiving, by the companion device, the peripheral data and processing the peripheral data into processed data, sending, by the companion device, the processed data to the wearable device, and receiving, by the wearable device, the processed data and utilizing the processed data to complete a computing process.

In another general aspect, a device, a system, a non-transitory computer-readable medium (having stored thereon computer executable program code which can be executed on a computer system), and/or a method can perform a process with a method including communicatively coupling a wearable device with a companion device, mirroring, by the companion device, data associated with a peripheral device of the wearable device as peripheral data, receiving, by the companion device from a wearable device, the peripheral data, generating, by the companion device, a result associated with a completion of a computing process by the companion device, the computing process is configured to use the peripheral data, and communicating, by the companion device to the wearable device, the result associated with the completion of the computing process.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a block diagram of a high-level split-compute architecture according to an example implementation.

FIG. 2 illustrates a block diagram of the high-level split-compute architecture with a shared runtime environment according to an example implementation.

FIG. 3 illustrates a block diagram of a wearable device split-compute architecture according to an example implementation.

FIG. 4 illustrates a block diagram of a high-level split-compute architecture according to an example implementation.

FIG. 5 illustrates a block diagram of activity elements in a wearable device application according to an example implementation.

FIG. 6 illustrates a block diagram of a wearable device application in a wearable device runtime environment according to an example implementation.

FIG. 7 illustrates a block diagram of a system using a split-compute architecture according to an example implementation.

FIG. 8 is a block diagram illustrating a companion device runtime environment according to an example implementation.

FIG. 9 is a block diagram of a method of operating a split-compute system according to an example implementation.

FIG. 10 is a block diagram of a method of operating a split-compute system according to an example implementation.

FIG. 11 is a block diagram of a method of operating a companion device according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Wearable devices can provide only a few hours of battery life with a display on. For example, computationally expensive operations such as image rendering, distortion correction, location services, and/or the like for wearable display optics may not always be possible to execute efficiently on a low-power embedded system implemented in the wearable device. Therefore, display architectures for thin-client wearable devices (e.g., smart glasses), however, can have the opportunity to reduce device onboard power and thermal footprint, by offloading computation-intensive operations (e.g., graphics operations) to a companion device (e.g., a mobile device, a smartphone, a server, and/or the like).

Some wearable devices can have implementation constraints. For example, a smart glasses implementation constraint can include (1) smart glasses should amplify key services through wearable computing. This can include supporting technologies such as AR and visual perception. For example, a smart glasses implementation constraint can include (2) smart glasses should last a full day of use on a single charge. For example, a smart glasses implementation constraint can include (3) smart glasses should look and feel like real glasses. Wearable devices can include augmented reality (AR) and virtual reality (VR) devices. Wearable devices can include smart glasses, head worn devices, and/or head mount devices. The wearable devices, head worn devices, and/or head mount devices can be AR/VR devices. Fully stand-alone wearable devices (e.g., smart glasses) solutions with mobile SoCs that have the capability to support the desired features may not meet the power and industrial design constraints listed above. On-device compute solutions that meet constraints (1), (2) and (3) may be difficult to achieve with current technologies. Current technology is limited in that stand-alone solutions with mobile system on a chip (SoC) technologies that meet the functionality requirements won't meet the power and industrial design constraints listed above.

A split-compute architecture can be used to solve the problems associated with existing wearable devices technology implementations meeting the aforementioned constraints. A split-compute architecture can be an architecture that moves an application runtime environment to a remote compute endpoint, such as a smartphone, a server, the cloud, a desktop computer, and the like, hereinafter often referred to as a companion device. In some implementations, display content can be streamed from the companion device back to the wearable device. Continuing the smart glasses example, the majority of the compute and rendering does not happen on the smart glasses, therefore the split-compute architecture can allow leveraging low-power processor and/or low-power microcontroller MCU based systems. In some implementations, the split-compute architecture combined with a wearable device including an MCU can allow minimizing power usage, meeting constraints (1) and (2) and (3). With new innovation in codecs and networking, it is possible to sustain the required networking bandwidth in a low power manner. In some implementations, wearable devices can communicate with a companion device over a well-defined protocol. This architecture can be platform independent.

In some implementations, peripheral devices such as an inertial measurement unit (IMU) and camera sensors can be configured to generate peripheral data on the wearable device. The companion device may be configured to use the peripheral data in some computing processes. For example, an application operating on the companion device can be configured to use peripheral data generated by an IMU of the wearable device. The application could request the peripheral data from the wearable device. However, in an example implementation, the peripheral data can be stored (e.g., in a memory) of the companion device. In an example implementation, the wearable device can be configured to communicate (e.g., stream) peripheral data anytime (e.g., automatically, without being requested, and the like) new peripheral data becomes available. In an example implementation, the peripheral data of the wearable device can be mirrored (e.g., a duplicate memory location) on the companion device. In an example implementation, the peripheral data of the companion device can be mirrored (e.g., a duplicate memory location) on the wearable device.

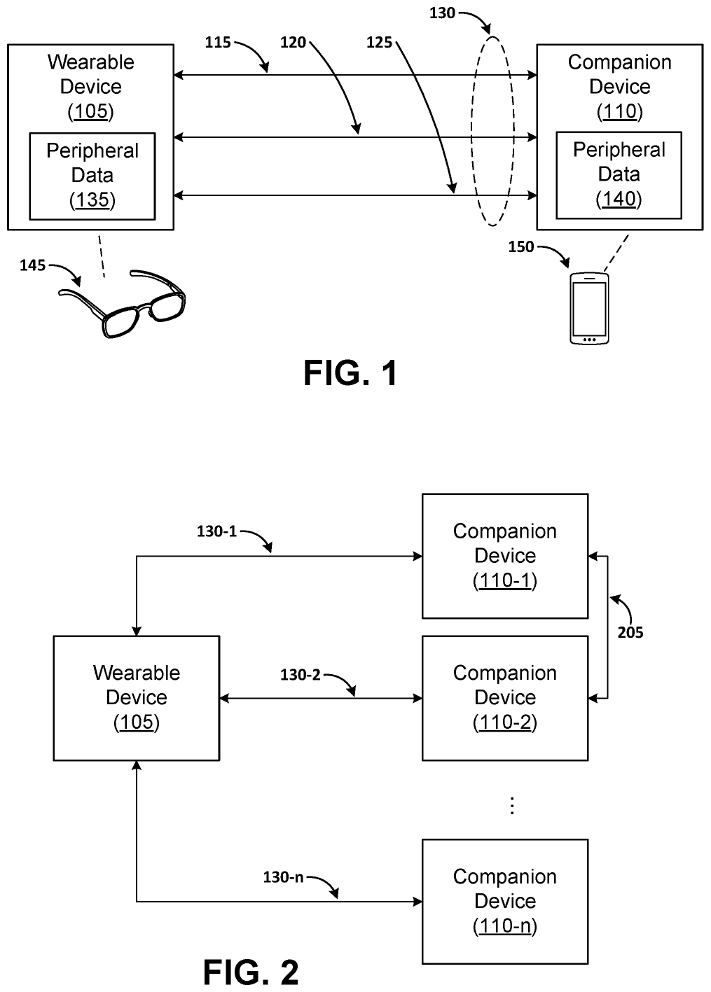

FIG. 1 illustrates a block diagram of a high-level split-compute architecture according to an example implementation. As shown in FIG. 1, the split-compute architecture can include a wearable device 105 including peripheral data 135 and a companion device 110 including peripheral data 140. In an example implementation, the wearable device 105 can be smart glasses, an augmented reality/virtual reality headset, a head mounted display (HMD), a smart watch, a smart ring, and/or the like. As an example, FIG. 1 shows the wearable device 105 as smart glasses 145. In an example implementation, the companion device 110 can be another wearable device, a mobile device, a smart phone, a tablet, a server, and a device including a processor and an operating system. As an example, FIG. 1 shows the companion device 110 as smart phone 150.

The wearable device 105 and the companion device 110 can be communicatively coupled. For example, the wearable device 105 and the companion device 110 can be communicatively coupled wired or wirelessly. In other words, the wearable device 105 and the companion device 110 can be endpoints of a two-way, wired and/or wireless, communication link. As an example, the wearable device 105 and the companion device 110 can communicate an audio stream and/or video stream over communications line 115. As an example, the wearable device 105 and the companion device 110 can communicate data (e.g., IMU, camera, input, and/or the like) over communications line 120. As an example, the wearable device 105 and the companion device 110 can communicate a control stream over communications line 125. Communications line 115, communications line 120, and/or communications line 125 can be referred to collectively as communications line 130. In some implementations, the communications line 130 can be bi-directional.

In some implementations, the companion device 110 can include a runtime environment the wearable device 105 can connect to. In some implementations, the wearable device 105 can stream data such as IMU and camera imagery into the runtime environment. In some implementations, the runtime environment of the companion device 110 can be configured to perform the tracking, perception and/or application rendering and/or deliver the output back to the wearable device 105 through a graphics application programming interface (API), such as encoded video or rendering commands. In some implementations, the runtime environment can be a code or software application and/or container executing on the companion device 110. In some implementations, the runtime environment can be software operating on the companion device 110 at the same time as the wearable device 105 and/or during a time when the wearable device 105 and the companion device 110 are communicatively coupled. In some implementations, input is captured from the wearable device 105 and injected into (e.g., communicated to) the runtime environment of the companion device 110.

In some implementations, the runtime environment of the companion device 110 can be configured to perform the tracking, perception and application rendering and deliver the output back to the wearable device 105 through a graphics application programming interface (API), such as encoded video or rendering commands. In some implementations, input is captured from the wearable device 105 and injected into (e.g., communicated to) the runtime environment of the companion device 110.

As an example, absent the companion device 110, a computing process would entirely be executed on the wearable device 105. The computing process can be any computing process associated with the function of the wearable device. For example, the computing process can be a computing process configured to display content (e.g., as an image or video) on a display of the wearable device 105. The computing process can be any computing process including computer instructions (e.g., code) stored on a memory of the wearable device 105 that are executed by a processor of the wearable device 105. The computer instructions (e.g., code) can be a plurality of tasks executed by the processor of the wearable device. In some implementations, a task(s) can be implemented as a service. A service can be, for example, a machine-to-machine interaction over a network. A service can be implemented as a background operation. For example, a service can perform network transactions, play audio, perform I/O, interact with a content provider, and/or the like from the background.

By including the companion device 110 (e.g., the runtime environment of the companion device 110), device onboard power usage and thermal footprint can be reduced by offloading one or more tasks of the plurality of tasks to the companion device 110. In an example implementation, the plurality of tasks can be fragmented. Fragmenting tasks can include methodically and/or randomly assigning plurality of tasks between the wearable device 105 and the companion device 110. For example, methodically assigning plurality of tasks between the wearable device 105 and the companion device 110 can be based on resource usage. For example, if the amount of resources used to cause a task (or tasks) to be executed (noting that executing a task includes performing computer operations) on the companion device 110 is greater than executing the task (or tasks) on the wearable device 105, then the task (or tasks) can be executed on the wearable device 105.

For example, a task (or tasks) can include and/or use peripheral data (e.g., computer data, IMU data, a high-resolution image, and/or the like) captured by a peripheral device of the wearable device 105. If communicating the peripheral data uses more resources (e.g., battery resources of the wearable device 105) than a task including processing the data by the wearable device 105, the wearable device 105 could be assigned to complete the task. Otherwise, the companion device 110 should be assigned to complete the task. In this example implementation, both the wearable device 105 and the companion device 110 are capable of performing the task (or tasks). In some implementations, two or more companion devices may be used to complete the process including the plurality of tasks.

When processing the task, the companion device 110 may require data associated with a peripheral device of the wearable device 105. Instead of requesting and/or receiving the data from the wearable device 105, in an example implementation, the companion device 110 can read the data from the peripheral data 140. In other words, in an example implementation, an application executing on the companion device 110 can read data associated with a peripheral device of the wearable device 105 from the peripheral data 135 because the peripheral data 135 is mirrored on the companion device 110 as the peripheral data 140. Further, in an example implementation, an application executing on the wearable device 105 can read data associated with a peripheral device of the companion device 110 from the peripheral data 140 because the peripheral data 140 is mirrored on the wearable device 105 as the peripheral data 135.

In some implementations, when the wearable device 105 is processing a task, the wearable device 105 may require data associated with a peripheral device of the companion device 110. Instead of requesting and/or receiving the data from the companion device 110, in an example implementation, the wearable device 105 can read the data from the peripheral data 140. In other words, in an example implementation, an application executing on the wearable device 105 can read data associated with a peripheral device of the companion device 110 from the peripheral data 140 because the peripheral data 140 is mirrored on the wearable device 105 as the peripheral data 135. In some example implementations, peripheral data (or data obtained from a peripheral device) can include IMU data, image data, audio data, microphone data, multi-channel microphone data, other camera data (e.g., depth data), ambient light sensor (ALS) data, and/or the like.

FIG. 2 illustrates a block diagram of the high-level split-compute architecture with a shared runtime environment according to an example implementation. As shown in FIG. 2, the wearable device 105 is communicatively coupled to two or more companion devices 110-1, 110-2, . . . 110-n via communications lines 130-1, 130-2, . . . 130-n respectively. In some implementations, the wearable device 105 could roam between various companion devices 110-1, 110-2, . . . 110-n, selecting the companion devices 110-1, 110-2, . . . 110-n that provides the best experience at that point in time. The wearable device 105 can connect to multiple companion devices 110-1, 110-2, . . . 110-n runtimes simultaneously. Therefore, the wearable device 105 can connect to multiple runtime environments simultaneously. Further, although not shown, peripheral data 135 can be mirrored on multiple companion devices 110-1, 110-2, . . . 110-n simultaneously.

For example, the runtime environment associated with companion device 110-1 can be configured to project content onto a display of the wearable device 105 while the runtime environment associated with companion device 110-2 can be configured to access the data sources (e.g., sensors) from the wearable device 105, a database server, the internet, and/or the like for processing. In addition, or alternatively, the companion devices 110-1, 110-2, . . . 110-n can be communicatively coupled (e.g., wired or wirelessly) to share resources and/or data. For example, companion device 110-1 and companion device 110-2 can be communicatively coupled enabling the runtime environment associated with companion device 110-1 to receive data from the runtime environment associated with companion device 110-2 for use when the runtime environment associated with companion device 110-2 generates images (or frames) to project content onto the display of the wearable device 105.

For example, companion device 110-1 and companion device 110-2 can be communicatively coupled (e.g., via communications line 205) enabling the runtime environment associated with companion device 110-2 to share processing resources with the runtime environment associated with companion device 110-1. For example, the runtime environment associated with companion device 110-1 may be instructed to generate content (e.g., an image, a frame, a map, and/or the like) that is more efficiently generated by the runtime environment associated with companion device 110-2. For example, companion device 110-2 may include a map database and map (e.g., image) generator. The runtime environment associated with companion device 110-1 may be instructed to generate content that includes a map. In this example, the runtime environment associated with companion device 110-1 can request a map from the runtime environment associated with companion device 110-2.

Continuing the example above, should a determination be made that the companion device 110 is to perform the task(s), the companion device 110 (or the wearable device 105) can determine that two or more companion devices 110 can perform the task(s). For example, the task(s) can include generating content (e.g., an image) to be displayed on the wearable device 105. In this example, the companion device 110-1 can be configured to generate the content. However, data used to generate the content may be generated by the companion device 110-2 which is then communicated (e.g., via communications line 205) from the companion device 110-2 to the companion device 110-1. For example, the companion device 110-2 can be a wearable smart watch configured to sense a user heart rate. Data representing the heart rate can be communicated from the companion device 110-2 to the companion device 110-1. Then, the companion device 110-1 can generate content using the data representing the heart rate and the content can be communicated to the wearable device 105 for display on a display of the wearable device 105.

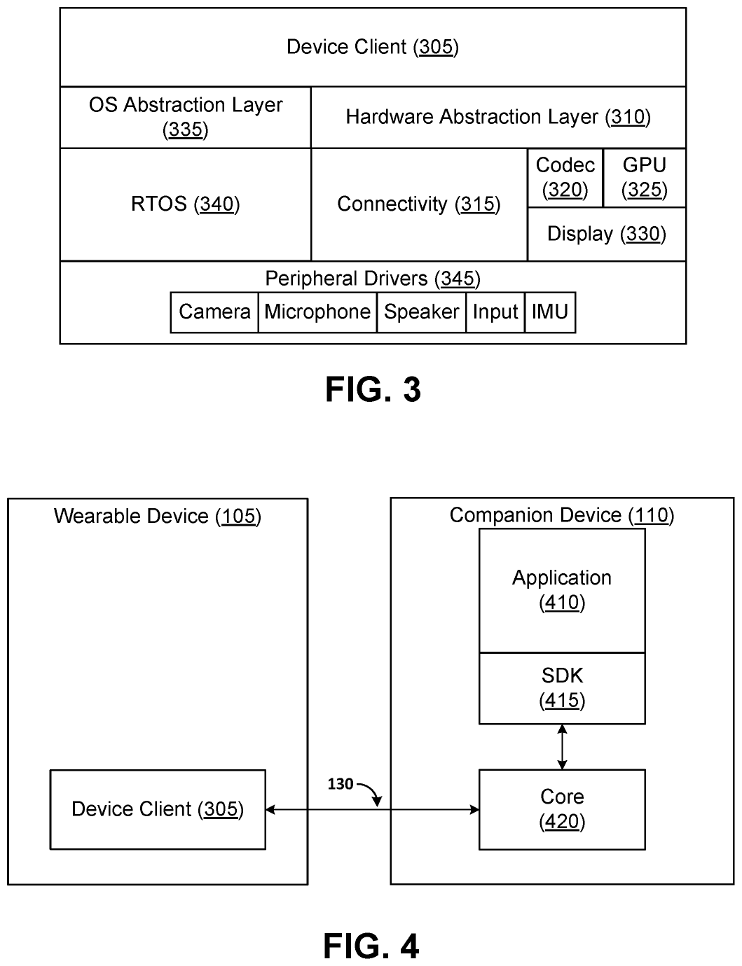

FIG. 3 illustrates a block diagram of a wearable device split-compute architecture according to an example implementation. As shown in FIG. 3, the wearable device split-compute architecture can include a hardware abstraction layer (HAL) 310 block. The HAL 310 can be a layer of software configured to interface between an operating system (e.g., RTOS 340) and a hardware device at a general or abstract level rather than at a hardware level. In some implementations, using abstraction layers can make the split-compute architecture platform independent. The HAL 310 can be called from the operating system kernel. In some implementations, the HAL 310 can be a virtual HAL. The virtual HAL can minimize interpretation latency based on the similarity in architectures of a guest and a host platform. Virtualization technique helps map the virtual resources to physical resources and use the native hardware for computations in the virtual HAL.

Accordingly, as an example, the HAL 310 can include a connectivity 315 block, a codec 320 block, a graphics processing unit (GPU) 325 block, and a display 330 block each configured to interface with a corresponding hardware device. For example, the connectivity 315 can be configured to interface between the operating system (e.g., RTOS 340) and Bluetooth hardware, WIFI hardware, ultra-wideband (UWB) hardware, 5G hardware, and/or the like. Therefore, the wearable device split-compute architecture can be configured to utilize any connectivity hardware designed into the wearable device 105.

For example, the codec 320 can be configured to interface between the operating system (e.g., RTOS 340) and an encoder and/or a decoder (e.g., a hardware-based encoder and/or decoder). The codec 320 standard can be, for example, H.265, H.264, MPEG, VP9, machine learned, and/or the like. The codec 320 can be an image, video, and/or audio codec. Therefore, the wearable device split-compute architecture can be configured to utilize any codec software and/or hardware designed into the wearable device 105. For example, the GPU 325 can be configured to interface between the operating system (e.g., RTOS 340) and GPU hardware (e.g., a GPU ASIC). Therefore, the wearable device split-compute architecture can be configured to utilize any GPU (e.g., to render an image on a display system) designed into the wearable device 105. For example, the display 330 can be configured to interface between the operating system (e.g., RTOS 340) and display hardware (e.g., a wearable device display). Therefore, the wearable device split-compute architecture can be configured to utilize any display (e.g., display driver system) designed into the wearable device 105.

As shown in FIG. 3, the wearable device split-compute architecture can include an operating system (OS) abstraction layer (OSAL) 335. In some implementations, using abstraction layers can make the split-compute architecture platform independent. The OSAL 335 can be configured to provide an interface to common system functions offered by the OS of the wearable device 105. These OSAL 335 can simplify development and porting software (e.g., applications) to multiple OS and hardware platforms. In some implementations, the OSAL 335 can operate as (or similar to) an application programming interface (API). In some implementations, the OSAL 335 can be platform dependent.

The OSAL 335 can include a real-time operating system (RTOS) 340 block. The RTOS 340 can be configured to process, for example, multi-threaded applications to meet real-time deadlines. For example, the RTOS 340 can be configured to process a plurality of tasks each (or a grouping of tasks) having a maximum completion time. Although an RTOS is illustrated, any OS can be used. For example, a high-level operating system (HLOS) can be used. In a split-compute system, using tasks enables distribution of these tasks (or groups of tasks) between computing devices. For example, a content display operation for the wearable device 105 can be divided between the wearable device 105 and the companion device 110 (e.g., the runtime environment associated with companion device 110). In other words, the wearable device 105 (and/or the companion device 110) can be configured to (e.g., using the wearable device split-compute architecture) cause the companion device 110 to perform a portion (a task or a grouping of tasks) of a process (e.g., content display). Causing a device to perform a task can include sending an instruction configured to initiate processing and/or trigger processing of a task by the device and/or another device(s). A computing process can be initiated by a user of the wearable device providing corresponding user input (e.g., a gesture) to the wearable device. In some implementations, the wearable device can initiate the computing process based on another computing process, based on a spatial position of the wearable device, and/or the like.

As shown in FIG. 3, the wearable device split-compute architecture can include a peripheral drivers 345 block. The peripheral drivers 345 can be configured to interface between the OS and a peripheral device. For example, the wearable device 105 can include a plurality of peripheral devices including, for example, a camera(s), a microphone(s), a speaker(s), an input(s), an inertial measurement unit(s) (IMU), and/or the like. Therefore, the peripheral drivers 345 can be configured to interface between the RTOS 340 and the peripheral device(s) of the wearable device 105.

As shown in FIG. 3, the wearable device split-compute architecture can include a device client 305. The device client 305 can be configured to control communication between the wearable device 105 and the companion device 110. For example, device client 305 can be configured to generate, initialize, and control the communications line 130 and the communications over the communications line 130. The communications line 130 can operate as, for example, a socket (e.g., a network socket, a TCP/IP network socket, and the like). A socket can be one endpoint of a two-way communication link between computer code (e.g., applications, programs, software systems, and/or the like) running on two computing devices. For example, a bi-directional handshake can be used indicating that both the client and the host determine what capabilities each support. The socket mechanism can be configured to provide inter-process communication (IPC) by establishing named communication contact points between two endpoints and/or between two endpoints and an intermediate device (e.g., an access point (AP)). A socket can be configured to provide bidirectional first-in first-out (FIFO) communication channel. A socket connecting to the network is created at each end of the communication. As an example, each socket can have an address (or memory location). The address (or memory location) can be, for example, an IP address and a port number. Accordingly, the device client 305 can be configured to write to and read from a socket associated with the companion device 110 (or the runtime environment associated with companion device 110). In some implementations, the device client 305 can be platform independent.

In some implementations, a software development kit (SDK) can be associated with the wearable device 105 and the companion device 110. The SDK can be used when developing applications for the wearable device 105 and/or the companion device 110. The SDK can enable the implementation of the split-compute architecture. Therefore, any wearable device 105 and/or companion device 110 (regardless of the hardware and/or software platform) that includes the split-compute architecture can use an application that was developed using the SDK. Therefore, an application does not have to be developed and ported to each hardware and/or software platform that may be used as a wearable device 105 and/or the companion device 110. The SDK can be included (or have elements that can be included) with the application when the application is installed on the wearable device 105 and/or the companion device 110.

FIG. 4 illustrates a high-level split-compute architecture according to an example implementation. As shown in FIG. 4, a system can include the wearable device 105 and the companion device 110. The split-compute architecture for the system can include a device client 305 block associated with the wearable device 105, an application 410 block, an SDK 415 block, and a core 420 block associated with the companion device 110. As mentioned above, the device client 305 can be configured to control communication between the wearable device 105 and the companion device 110. The core 420 can be configured to control communication between the companion device 110 and the wearable device 105. Accordingly, the core 420 can be configured to, at least, generate, initialize, and control the communications line 130 and the communications over the communications line 130. The communications line 130 can operate as, for example, a socket (as described above).

In some implementations, the application 410 can include the file format for applications used on the OS that holds the application logic (e.g., the Android package kit (APK)). In some implementations, wearable device applications can link with a stub (e.g., not a complete) version of the SDK to support compile and testing services. In some implementations, at runtime, the application 410 can load the wearable device SDK 415 directly from a wearable device runtime environment. In some implementations, the SDK 415 can provide developers the application programming interface (API) used to build wearable device applications. In some implementations, an API versioning scheme allows introduction of new APIs while maintaining backwards compatibility. In some implementations, the wearable device runtime environment can be a collection of core services responsible for maintaining the wearable device execution environment. In some implementations, wearable device applications may not interact with the core services directly. In some implementations, one or more interaction may go through the SDK. In some implementations, the device client 305 can be a thin client running on the wearable device 105 hardware.

As an example, the application 410 can be configured to generate (or help generate) content for display on the wearable device 105. For example, the application can be configured to process a task(s). For example, the application can generate the content (e.g., as an image) and communicate the content to the core 420 via the SDK 415. Communicating the content to the core 420 via the SDK 415 can be one of the features that allows the application 410 to be developed for any hardware and/or software platform. For example, the SDK 415 can be configured to communicate with the application 410 when the application 410 is developed. The SDK 415 can also be configured to communicate with the core 420 associated with a plurality of hardware and/or software platforms. After receiving the content, the core 420 can communicate the content to the wearable device 105 via the device client 305 using, for example, a pre-established socket. The application 410 can be configured to generate content based on data received from the wearable device 105. For example, the peripheral drivers 345 can sense and communicate data, as peripheral data, (e.g., IMU data) to the application module 630 via the device client 305 and the core 420 using the communications line 120. In other words, peripheral data can be the data that is collected by and/or processed by (e.g., compressed, packaged, parsed, filtered, denoised, and/or the like) the peripheral device via the peripheral drivers 345 and packaged for communication with and use by the wearable device 105 and/or the companion device 110.

As mentioned above, in some implementations, the wearable device 105 can be configured to connect to more than one companion device 110 at a given time. In some implementations, a different companion device 110 can be configured to provide different services (e.g., using an application 410). In some implementations, with low-latency, high-bandwidth 5G connections becoming mainstream, the companion device 110 can be configured to operate in the cloud (e.g., connecting through 5G standards).

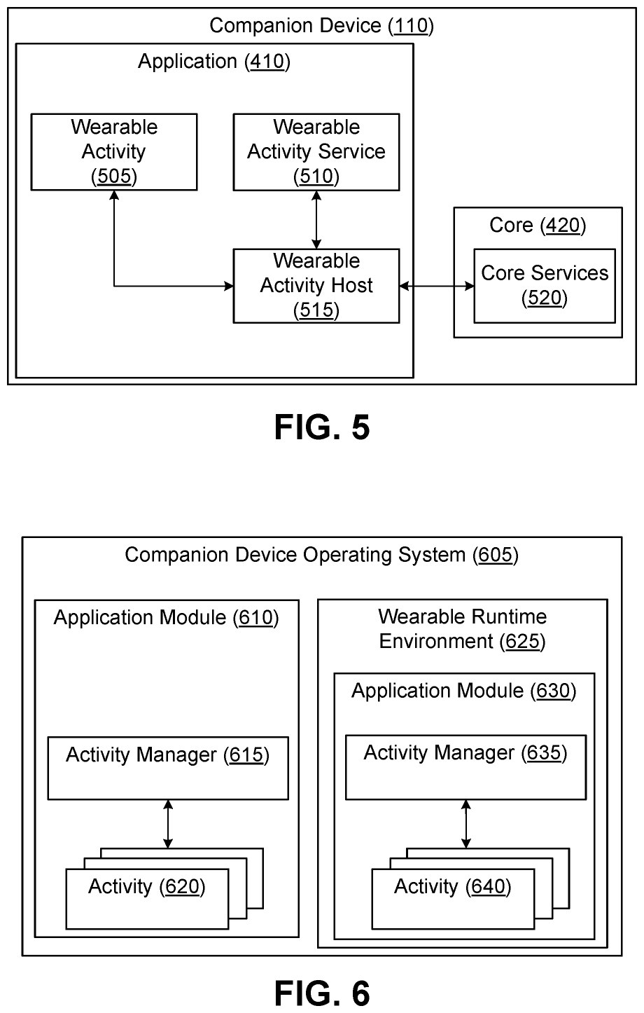

FIG. 5 illustrates a block diagram of activity elements in a wearable device application according to an example implementation. As shown in FIG. 5, the application 410 can include a wearable activity 505 block, a wearable activity service 510 block, and a wearable activity host 515 block, and the core 420 can include a core services 520 block.

In some example implementations, wearable device application design can resemble an activity model. Referring to FIG. 3, the RTOS 340 can be configured to process, a task, a plurality of tasks each (or a grouping of tasks) having a maximum completion time. Therefore, each activity can be a task executed in a parallel process and having a time (or amount of time) to be completed by.

In an example implementation, activities can be executed in a service context. In some implementations, running in a service context can allow the application 410 to run concurrently with companion device 110 applications. In some implementations, the application can continue running and rendering when a companion device 110 display is off.

In some implementations, one or more application 410 can include a wearable activity service 510. The wearable activity service 510 can be configured to expose the wearable activity 505 so that the wearable activity 505 can be instantiated by the SDK 415. Therefore, the wearable activity 505 can be instantiated at a later point in time. From a developer's point of view, the wearable activity service 510 can be boilerplate code that does not directly relate to application 410 logic. The wearable activity 505 can be the code related to application 410 logic. In some implementations, wearable activity 505 can be managed by an activity manager and behave similarly to a standard OS activity counterpart.

In some implementations, the service binding can be used by the wearable device runtime environment to start and manage the life cycle of the application 410. Once the activity manager binds to the service as part of a launch flow, the SDK 415 can instantiate and attach a wearable activity host 515 as, for example, a class that can be responsible for general activity state control. For example, during initialization the wearable activity host 515 can request a surface from a window manager. This surface is then used as a backing store for a virtual display that's used to render the contents of the application 410.

FIG. 6 illustrates a block diagram of a wearable device application in a wearable device runtime environment according to an example implementation. As shown in FIG. 6, a companion device OS 605 can simultaneously process two or more application environments. For example, the companion device OS 605 can include an application module 610. The application module 610 can be associated with standard OS application activity. In addition, the companion device OS 605 can include an application module 630 operating in association with a wearable runtime environment 625. The wearable runtime environment 625 can be associated with the wearable device 105.

An activity(s) 620, 640 can be a single, focused task that the application can perform. For example, some applications can include a user interface (UI). Therefore, the activity(s) 620, 640 can be configured to create a window to place the UI. The window can be a full-screen window, a floating window, embedded into other windows, a hidden window, and/or the like. The different types of windows can be associated with different activity(s) 620, 640. The activity(s) 620, 640 can be configured for any task, a window is just one example.

The activity manager 615, 635 can be configured to communicate information about, and interact with the activities 620, 640. The activity manager 615, 635 can be further configured to communicate information about, and interact with tasks, threads, services and other processes.

In an example implementation, the wearable runtime environment 625 can be a virtual runtime environment. The virtual runtime environment can be configured to operate in the background of a computing device. Therefore, the wearable runtime environment 625 can be a virtual runtime environment associated with the wearable device 105 and configured to operate as a background process on the companion device 110. In other words, the wearable runtime environment 625 can operate without a user interface shown on a display of the companion device 110. For example, the wearable runtime environment 625 can operate in a hidden window of the companion device 110. Therefore, a user of the companion device 110 may have no visual or I/O control of an application using the wearable runtime environment 625 if the wearable runtime environment 625 is a virtual runtime environment.

In an alternative, or additional implementation, the application 410 and/or the application module 630 can be a virtual process. The virtual process can be configured to operate in the background of a computing device. Therefore, the application 410 and/or the application module 630 can be a virtual process associated with the wearable device 105 and configured to operate as a background process on the companion device 110. In other words, the application 410 and/or the application module 630 can operate without a user interface shown on a display of the companion device 110. For example, the application 410 and/or the application module 630 can operate in a hidden window of the companion device 110. Therefore, a user of the companion device 110 may have no visual or I/O control of the application 410 and/or the application module 630 if the process is a virtual runtime process.

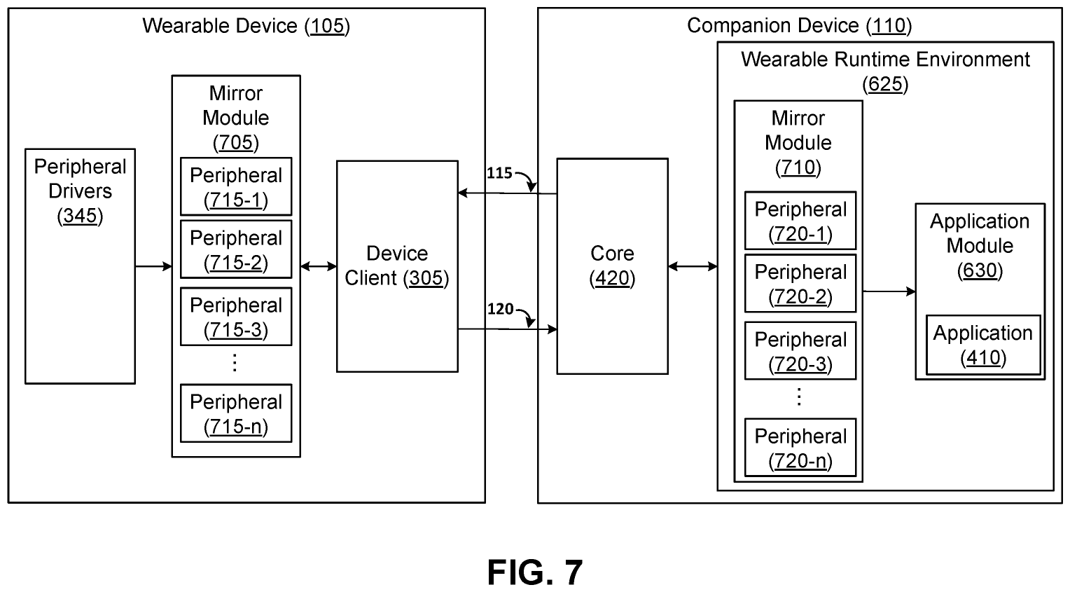

FIG. 7 illustrates a block diagram of a system using a split-compute architecture according to an example implementation. As shown in FIG. 7, the system includes the wearable device 105 and the companion device 110. The wearable device 105 can include the device client 305, a mirror module 705, and the peripheral drivers 345. The mirror module 705 can include peripheral 715-1, 715-2, 715-3, . . . , and peripheral 715-n. The peripheral 715-1, 715-2, 715-3, . . . , and peripheral 715-n can each include peripheral data. The companion device 110 can include the core 420 and the wearable runtime environment 625. The wearable runtime environment 625 can include the application module 630 including the application 410 and a mirror module 710. The mirror module 710 can include peripheral 720-1, 720-2, 720-3, . . . , and peripheral 720-n. The peripheral 720-1, 720-2, 720-3, . . . , and peripheral 720-n can each include peripheral data. This example implementation can be used to describe a signal flow associated with the companion device 110 mirroring and using peripheral data.

In this example implementation, the application 410 can be configured to generate, for example, content, a head pose, a rendered image, and/or the like. As an example, generating a head pose (e.g., a head pose operation) can include using an image and/or IMU data captured by the wearable device 105. In this example, when a camera (e.g., a peripheral) captures an image as image data, the image data can be stored in, for example, peripheral 715-1 as peripheral data. Further, when an IMU senses data, the IMU data can be stored in, for example, peripheral 715-2 as peripheral data.

In this example implementation, peripheral 715-1, 715-2, 715-3, . . . , and peripheral 715-n each can be mirrored on the companion device 110 as peripheral 720-1, 720-2, 720-3, . . . , and peripheral 720-n. Mirroring, data mirroring, or mirrored data can include copying data from a first location to a second location in real time. The data is copied in real time, therefore the data stored in the second location is an exact copy of the data in the first location. The first and second locations can be a memory location (e.g., an addressable memory location). In an example implementation, the first location can be a memory of the wearable device 105 and the second location can be a memory of the companion device 110 (e.g., a memory associated with the wearable runtime environment 625). Continuing the above example, peripheral 720-1 is a mirror (e.g., an exact copy) of peripheral 715-1 and peripheral 720-2 is a mirror (e.g., an exact copy) of peripheral 715-2. Therefore, the peripheral data of peripheral 720-1 is the same peripheral data of peripheral 715-1 and the peripheral data of peripheral 720-2 is the same peripheral data of peripheral 715-2.

Accordingly, the application 410 can be configured to generate, for example, content, a head pose, a rendered image, and/or the like using the peripheral data of peripheral 720-1 and peripheral data of peripheral 720-2. The generated content, a head pose, a rendered image, and/or the like should be substantially the same should the process be performed by the wearable device 105. Thus, conserving resources of the wearable device 105.

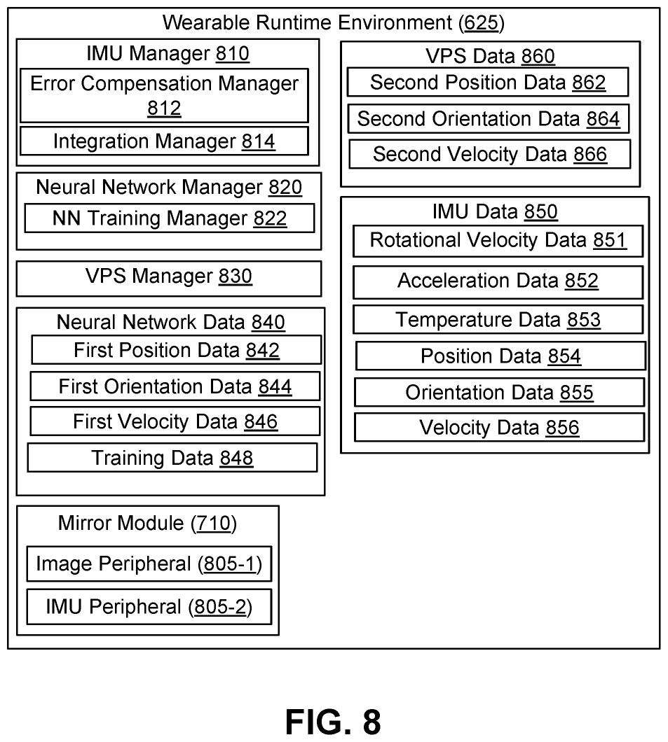

FIG. 8 is a block diagram illustrating a companion device runtime environment 625 according to an example implementation. The runtime environment 625 can be included in a memory of the companion device 110. The memory can include both volatile memory (e.g., RAM) and non-volatile memory, such as one or more ROMs, disk drives, solid state drives, and the like. In an example implementation, the runtime environment 625 can include modules (e.g., software code, computer instructions, and/or the like) configured to generate head pose data. The head pose data can be generated based on image data and/or IMU data.

In some implementations, one or more of the components of the runtime environment 625 can be associated with processors configured to process instructions stored in the memory. Examples of such instructions as depicted in FIG. 8 include the mirror module 710, an IMU manager 810, a neural network manager 820, and a visual positioning system manager 830. Further, as illustrated in FIG. 8, the runtime environment 625 can be configured to store various data, which is described with respect to the respective modules that use such data.

In this example, mirror module 710 includes image peripheral 805-1 and IMU peripheral 805-2 each including peripheral data that is a mirror of peripheral data on the wearable device 105. The IMU manager 810 can be configured to obtain IMU data 850. In some implementations, the IMU manager 810 can be configured to obtain the IMU data 850 by reading peripheral data from IMU peripheral 805-2. As shown in FIG. 8, the IMU manager 810 can include an error compensation manager 812 and an integration manager 814.

The error compensation manager 812 can be configured to store IMU calibration parameters. The error compensation manager 812 can be further configured to receive IMU output (IMU data 850) from, e.g., IMU manager 810, and use the IMU calibration parameter values to compensate the IMU output for errors. The error compensation manager 812 can further be configured to, after performing the error compensation, generate the IMU data 850.

The integration manager 814 can be configured to perform integration operations (e.g., summing over time-dependent values) on the IMU data 850. For example, the rotational velocity data 851 can be integrated over time to generate an orientation. Moreover, the acceleration data 852 can be integrated over time twice to generate a position. Accordingly, the integration manager 814 can be configured to generate a 6DoF pose (position and orientation) from the IMU output, e.g., rotational velocity data 851 and acceleration data 852.

The IMU data 850 can represent the gyro and accelerometer measurements, rotational velocity data 851 and acceleration data 852 in a world frame (as opposed to a local frame, e.g., frame of the IMU), compensated for an error(s) using the IMU calibration parameter values. Moreover, IMU data 850 includes 6DoF pose and movement data, position data 854, orientation data 855, and velocity data 856, that are derived from the gyro and accelerometer measurements. Finally, in some implementations, the IMU data 850 can include IMU temperature data 853; this may indicate further error (for correction by the error compensation manager 812) in the rotational velocity data 851 and acceleration data 852.

The neural network manager 820 can be configured to obtain as input the rotational velocity data 851 and acceleration data 852 and generate the neural network data 840 including first position data 842, first orientation data 844, and first velocity data 846. In some implementations, the input rotational velocity data 851 and acceleration data 852 can be generated by the error compensation manager 812 acting on raw IMU output values, e.g., with errors compensated by IMU calibration parameter values. As shown in FIG. 8, the neural network manager 820 can include a neural network training manager 822.

The neural network training manager 822 can be configured to receive training data 848 and generate the neural network data 840, including data concerning layers and cost functions and values. In some implementations, the training data 848 can include movement data generated from measurements of users wearing the wearable device 105 and moving, for example, their heads and/or other parts of their bodies, as well as ground truth 6DoF pose data generated from those measurements. In some implementations, the training data 848 can include measured rotational velocities and accelerations from the movement, paired with measured 6DoF poses and velocities.

In addition, in some implementations, the neural network manager 820 can use historical data from the IMU to generate the first position data 842, first orientation data 844, and first velocity data 846. For example, the historical data can be used to augment the training data 848 with maps of previous rotational velocities, accelerations, and temperatures to their resulting 6DoF pose and movement results and hence further refine the neural network. In some implementations, the neural network represented by the neural network manager 820 is a convolutional neural network, with the layers being convolutional layers.

The visual positioning system (VPS) manager 830 can be configured to receive as input an image and generate VPS data 860, including second position data 862 and second orientation data 864. In some implementations, the VPS data can include second velocity data 866, e.g., 6DoF pose based on an image. The VPS manager 830 can be configured to obtain the image used to generate VPS data 860. In some implementations, the VPS manager 830 can be configured to obtain the image by reading peripheral data from image peripheral 805-1. The image or image data stored in image peripheral 805-1 can be a mirror of an image captured with a world-facing camera on the wearable device 105.

In some implementations, the accuracy level of the VPS manager 830 in producing the VPS data 860 can depend on the environment surrounding the location. For example, the accuracy requirements for indoor locations may be on the order of 1-10 cm, while the accuracy requirements for outdoor locations may be on the order of 1-10 m.

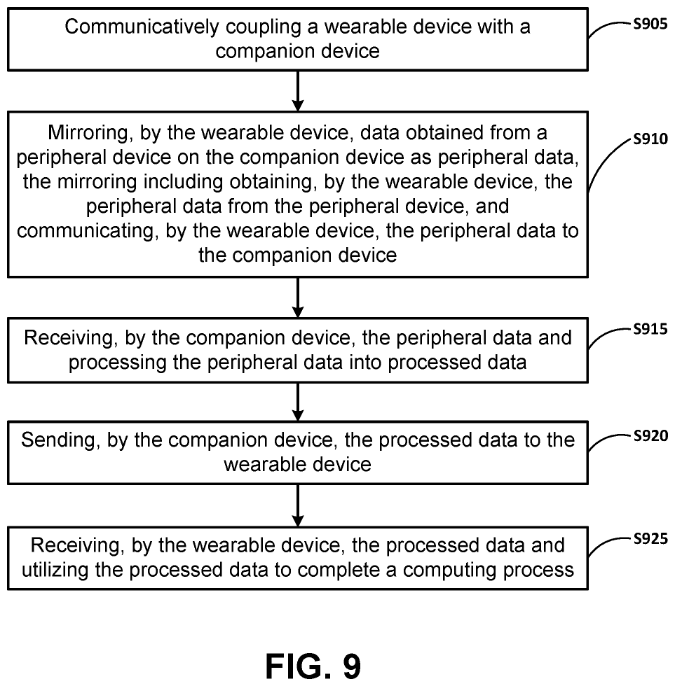

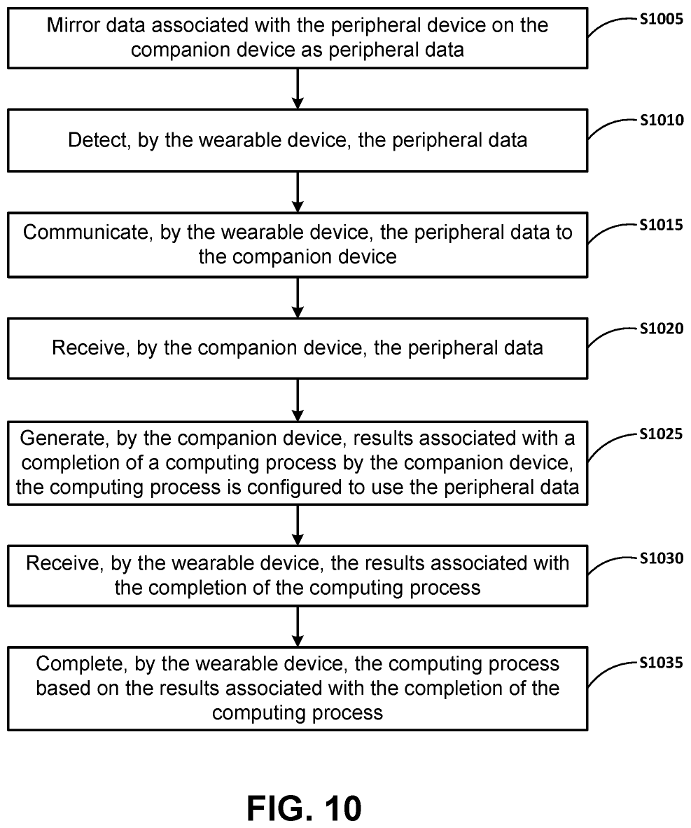

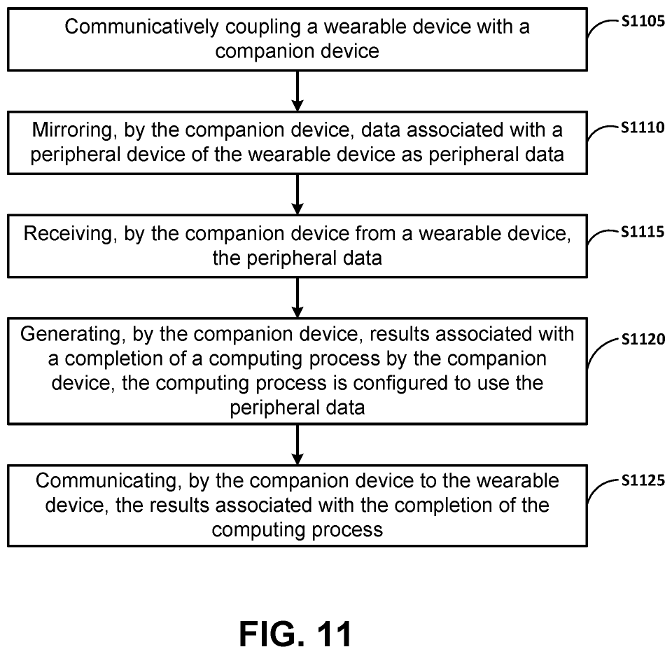

The head pose of the wearable device 105 can be generated by the companion device 110 based on the peripheral data of image peripheral 805-1 and/or IMU peripheral 805-2. For example, the head pose of the wearable device 105 can be generated by the companion device 110 based on the neural network data 840. For example, the head pose of the wearable device 105 can be generated by the companion device 110 based on the VPS data 860. For example, the head pose of the wearable device 105 can be generated by the companion device 110 based on the IMU data 850. For example, the head pose of the wearable device 105 can be generated by the companion device 110 based on the neural network data 840, the VPS data 860, and/or the IMU data 850. The generated head pose should be substantially the same should the process be performed by the wearable device 105. Thus, conserving resources of the wearable device 105. Further, the head pose can be generated within a maximum completion time because of the split-compute system and the mirrored peripheral data of image peripheral 805-1 and/or IMU peripheral 805-2.
Example 1. FIG. 9 is a block diagram of a method of operating a split-compute system including a wearable device and a companion device communicatively coupled to the wearable device according to an example implementation. As shown in FIG. 9, in step S905 communicatively coupling a wearable device with a companion device. The coupling can be triggered by either the wearable device, the companion device, or in response to a user command of a user of the wearable device or of the companion device. The wearable device can be “communicatively coupled” to the companion device if the wearable device is capable of, at least in part, transmitting to and/or receiving from the companion device one or more commands and/or data, such as, for example, via one or more wired and/or wireless communication links. In some implementations, a bi-directional handshake can be used indicating that both the client and the host determine what capabilities each support. In step S910 mirroring, by the wearable device, data obtained from a peripheral device on the companion device as peripheral data, including obtaining, by the wearable device, the peripheral data from the peripheral device, and communicating, by the wearable device, the peripheral data to the companion device. In here, the term “peripheral device” can be used to refer to an internal or external device of the wearable device that connects directly to the wearable device, such as for example, input/output devices of the wearable device, like an inertial measurement unit (IMU), etc. Herein, the term “mirroring” can be used to refer to a real-time operation of copying the peripheral data, as an exact copy, to the companion device. In step S915 receiving, by the companion device, the peripheral data and processing the peripheral data into processed data. The mirrored peripheral data can relate to a plurality of tasks each (or a grouping of the tasks) can have a maximum completion time. Here, the plurality of tasks or a portion of the plurality of tasks can be performed by the companion device when mirroring the peripheral data to the companion device. The results of the completed tasks can then be returned to the wearable device. In step S920 sending, by the companion device, the processed data to the wearable device. In step S925 receiving, by the wearable device, the processed data and utilizing the processed data to complete a computing process. Here, the computing process can can be started before or when the peripheral data is sent to the user, for example, when the wearable device is coupled with the companion device.
Example 2. The method of Example 1 can further include mirroring, by the wearable device, data obtained from a peripheral device of the companion device on the wearable device as companion device peripheral data includes receiving, by the wearable device, the companion device peripheral data from the companion device.
Example 3. The method of Example 1, wherein the peripheral data can be inertial measurement unit (IMU) data, the computing process can be a head pose operation, and completing the computing process by the wearable device can include using the results based on the head pose operation.
Example 4. The method of Example 1, wherein the peripheral data can be image data, the computing process can be a head pose operation, and completing the computing process by the wearable device can include using the results based on the head pose operation.
Example 5. The method of Example 1, wherein the peripheral data can be image data, the computing process can be an eye tracking operation, and completing the computing process by the wearable device can include using the results based on the eye tracking operation.
Example 6. The method of Example 1, wherein the wearable device can include a first socket, the companion device can include a second socket communicatively coupled to the first socket, and mirroring the data associated with a peripheral device can include communicating the peripheral data between the first socket and the second socket.
Example 7. The method of Example 1, wherein the wearable device can be smart glasses.
Example 8. The method of Example 1, wherein the companion device can be at least one of another wearable device, a mobile device, a smart phone, a tablet, a server, and a device including a processor and an operating system.
Example 9. FIG. 10 is a block diagram of a method of operating a split-compute system according to an example implementation. The system can include a wearable device including a device client, a hardware abstraction layer, an operating system abstraction layer, and at least one peripheral device driver. The system can include a companion device including a runtime environment associated with the wearable device. As shown in FIG. 10, in step S1005 mirror data associated with the peripheral device on the companion device as peripheral data. In step S1010 detect, by the wearable device, the peripheral data. In step S1015 communicate, by the wearable device, the peripheral data to the companion device. In step S1020 receive, by the companion device, the peripheral device. In step S1025 generate, by the companion device, results associated with a completion of a computing process by the companion device, the computing process is configured to use the peripheral data. In step S1030 receive, by the wearable device, the results associated with the completion of the computing process. In step S1035; and complete, by the wearable device, the computing process based on the results associated with the completion of the computing process.
Example 10. The method of Example 9, wherein the wearable device can be smart glasses.
Example 11. The method of Example 9, wherein the companion device can be at least one of another wearable device, a mobile device, a smart phone, a tablet, a server, and a device including a processor and an operating system.
Example 12. The method of Example 9, wherein the runtime environment can be a virtual runtime environment operating in the background on the companion device, and the mirror of the data associated with the peripheral device can be included in the virtual runtime environment.
Example 13. The method of Example 9, wherein the peripheral data can be inertial measurement unit (IMU) data, the computing process can be a head pose operation, and completing the computing process by the wearable device can include using the results based on the head pose operation.
Example 14. The method of Example 9, wherein the peripheral data can be image data, the computing process can be a head pose operation, and completing the computing process by the wearable device can include using the results based on the head pose operation.
Example 15. The method of Example 9, wherein the peripheral data can be image data, the computing process can be an eye tracking operation, and completing the computing process by the wearable device can include using the results based on the eye tracking operation.
Example 16. The method of Example 9, wherein the wearable device can include a first socket, the companion device can include a second socket communicatively coupled to the first socket, and mirroring the data associated with a peripheral device can include communicating the peripheral data between the first socket and the second socket.
Example 17. FIG. 11 is a block diagram of a method of operating a companion according to an example implementation. As shown in FIG. 11, in step S1105 communicatively coupling a wearable device with a companion device. In step S1110 mirroring, by the companion device, data associated with a peripheral device of the wearable device as peripheral data. In step S1115 receiving, by the companion device from a wearable device, the peripheral data. In step S1120 generating, by the companion device, results associated with a completion of a computing process by the companion device, the computing process is configured to use the peripheral data. In step S1125 communicating, by the companion device to the wearable device, the results associated with the completion of the computing process.
Example 18. The method of Example 17, wherein the wearable device can be smart glasses.
Example 19. The method of Example 17, wherein the companion device can be at least one of another wearable device, a mobile device, a smart phone, a tablet, a server, and a device including a processor and an operating system.
Example 20. The method of Example 17 can further include mirroring, by the companion device, data obtained from a peripheral device of the companion device on the wearable device as companion device peripheral data includes communicating, by the companion device, the companion device peripheral data to the companion device.
Example 21. The method of Example 17, wherein the peripheral data can be inertial measurement unit (IMU) data, the computing process can be a head pose operation, and completing the computing process by the wearable device can include using the results based on the head pose operation.
Example 22. The method of Example 17, wherein the peripheral data can be image data, the computing process can be a head pose operation, and completing the computing process by the wearable device can include using the results based on the head pose operation.
Example 23. The method of Example 17, wherein the peripheral data can be image data, the computing process can be an eye tracking operation, and completing the computing process by the wearable device can include using the results based on the eye tracking operation.
Example 24. The method of Example 17, wherein the wearable device can include a first socket, the companion device can include a second socket communicatively coupled to the first socket, and mirroring the data associated with a peripheral device can include communicating the peripheral data between the first socket and the second socket.
Example 25. The method of Example 17, wherein the companion device can include a virtual runtime environment and the mirror of the data associated with the peripheral device can be included in the virtual runtime environment.
Example 26. A method can include any combination of one or more of Example 1 to Example 25.
Example 27. A non-transitory computer-readable storage medium comprising instructions stored thereon that, when executed by at least one processor, are configured to cause a computing system to perform the method of any of Examples 1-26.
Example 28. An apparatus comprising means for performing the method of any of Examples 1-26.
Example 29. An apparatus comprising at least one processor and at least one memory including computer program code, the at least one memory and the computer program code configured to, with the at least one processor, cause the apparatus at least to perform the method of any of Examples 1-26.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method comprising:
communicatively coupling a wearable device with a companion device;
mirroring, by the wearable device, data obtained from a peripheral device of the wearable device on the companion device as peripheral data, including:
obtaining, by the wearable device, the peripheral data from the peripheral device, and
communicating, by the wearable device, the peripheral data to the companion device;
receiving, by the companion device, the peripheral data and processing the peripheral data into processed data;
sending, by the companion device, the processed data to the wearable device; and
receiving, by the wearable device, the processed data and utilizing the processed data to complete a computing process.

2. The method of claim 1 further comprising storing, by the wearable device, data obtained from a peripheral device of the companion device on the wearable device as companion device peripheral data includes receiving, by the wearable device, the companion device peripheral data from the companion device.

3. The method of claim 1, wherein
the peripheral data is inertial measurement unit (IMU) data,
the computing process is a head pose operation, and
completing the computing process by the wearable device includes using a result of the head pose operation.

4. The method of claim 1, wherein
the peripheral data is image data,
the computing process is a head pose operation, and
completing the computing process by the wearable device includes using a result of the head pose operation.

5. The method of claim 1, wherein
the peripheral data is image data,
the computing process is an eye tracking operation, and
completing the computing process by the wearable device includes using a result of the eye tracking operation.

6. The method of any of claim 1, wherein
the wearable device includes a first socket,
the companion device includes a second socket communicatively coupled to the first socket, and
storing the data associated with a peripheral device includes communicating the peripheral data between the first socket and the second socket.

7. The method of any of claim 1, wherein the wearable device is smart glasses.

8. The method of any of claim 1, wherein the companion device is at least one of another wearable device, a mobile device, a smart phone, a tablet, a server, and a device including a processor and an operating system.

9. A system comprising:
a wearable device; and
a companion device,
the wearable device including:
a device client,
a hardware abstraction layer,
an operating system abstraction layer, and
and at least one peripheral device driver,
the companion device including a runtime environment associated with the wearable device, and
the system configured to:
store data associated with the peripheral device on the companion device as peripheral data, including:
obtain, by the wearable device, the peripheral data from the peripheral device, and
communicate, by the wearable device, the peripheral data to the companion device;
receive, by the companion device, the peripheral data and processing the peripheral data into processed data;
send, by the companion device, the processed data to the wearable device; and
receive, by the wearable device, the processed data and utilizing the processed data to complete a computing process.

10. The system of claim 9, wherein the wearable device is smart glasses.

11. The system of claim 9, wherein the companion device is at least one of another wearable device, a mobile device, a smart phone, a tablet, a server, and a device including a processor and an operating system.

12. The system of claim 9, further comprising storing, by the wearable device, data obtained from a peripheral device of the companion device on the wearable device as companion device peripheral data includes receiving, by the wearable device, the companion device peripheral data from the companion device.

13. The system of claim 9, wherein
the runtime environment is a virtual runtime environment operating in as a background process on the companion device, and
the storing of the data associated with the peripheral device is included in the virtual runtime environment.

14. The system of claim 9, wherein
the peripheral data is inertial measurement unit (IMU) data,
the computing process is a head pose operation, and
completing the computing process by the wearable device includes using a result generated based on the head pose operation.

15. The system of claim 9, wherein
the peripheral data is image data,
the computing process is a head pose operation, and
completing the computing process by the wearable device includes using a result generated based on the head pose operation.

16. The system of claim 9, wherein
the peripheral data is image data,
the computing process is an eye tracking operation, and
completing the computing process by the wearable device includes using a result generated based on the eye tracking operation.

17. The system of claim 9, wherein
the wearable device includes a first socket,
the companion device includes a second socket communicatively coupled to the first socket, and
storing the data associated with a peripheral device includes communicating the peripheral data between the first socket and the second socket.

18. A method comprising:
communicatively coupling a wearable device with a companion device;
storing , by the companion device, data associated with a peripheral device of the wearable device as peripheral data;
receiving, by the companion device from a wearable device, the peripheral data;
generating, by the companion device, a result associated with a completion of a computing process by the companion device, the computing process is configured to use the peripheral data; and
communicating, by the companion device to the wearable device, the result associated with the completion of the computing process.

19. The method of claim 18, wherein the wearable device is smart glasses.

20. The method of claim 18, wherein the companion device is at least one of another wearable device, a mobile device, a smart phone, a tablet, a server, and a device including a processor and an operating system.

21. The method of claim 18, further comprising mirroring, by the companion device, data obtained from a peripheral device of the companion device on the wearable device as companion device peripheral data includes communicating, by the companion device, the companion device peripheral data to the companion device.

22. The method of claim 18, wherein
the peripheral data is inertial measurement unit (IMU) data,
the computing process is a head pose operation, and
completing the computing process by the wearable device includes using the result based on the head pose operation.

23. The method of claim 18, wherein
the peripheral data is image data,
the computing process is a head pose operation, and
completing the computing process by the wearable device includes using the result based on the head pose operation.

24. The method of claim 18, wherein
the peripheral data is image data,
the computing process is an eye tracking operation, and
completing the computing process by the wearable device includes using the result based on the eye tracking operation.

25. The method of claim 18, wherein
the wearable device includes a first socket,
the companion device includes a second socket communicatively coupled to the first socket, and
storing the data associated with a peripheral device includes communicating the peripheral data between the first socket and the second socket.

26. The method of claim 18, wherein
the companion device includes a virtual runtime environment, and
the storing of the data associated with the peripheral device is included in the virtual runtime environment.

27-32. (canceled)
